(19) United States
(12) Patent Application Publication
(10) Pub. No.: US 2017/0262785 A1
(43) Pub. Date: Sep. 14, 2017

(54) SMART SHIP BUSINESS DEVICE USING POSITIONING MEANS

(71) Applicant: Marinesoft. Co., Ltd., Busan (KR)

(72) Inventor: Jae In LEE, Busan (KR)

(73) Assignee: Marinesoft. Co., Ltd., Busan (KR)

(21) Appl. No.: 15/084,770

(22) Filed: Mar. 30, 2016

(30) Foreign Application Priority Data
Mar. 8, 2016 (KR) 10-2016-0027922

(51) Int. Cl. G06Q 10/06; H04W 4/00; H04W 76/02

(52) U.S. Cl. CPC G06Q 10/063114; H04W 76/02; H04W 4/008

(57) ABSTRACT

The present disclosure relates to a smart ship business device using positioning means while automatizing ship business using a smart device. The smart ship business device according to the present disclosure includes positioning means installed at an operation area of a ship, a positioning communication unit communicating with the positioning means, a second data extraction unit configured to extract a second data from a first data matching to the positioning means, an input unit configured to receive business information on the second data, and a portable terminal mounted with a transmitter configured to transmit to outside a third data inputted with the business information on the second data.

### CROSS-REFERENCE TO RELATED APPLICATION(S)

Pursuant to 35 U.S.C. §119 (a), this application claims the benefit of earlier filing date and right of priority to Korean Patent Application No. 10-2016-0027922, filed on Mar. 8, 2016, the contents of which are hereby incorporated by reference in their entirety.

### BACKGROUND OF THE DISCLOSURE

Field

The teachings in accordance with the exemplary embodiments of this present disclosure generally relate to a smart ship (shipping) business device configured to automatize a shipping business using a smart device by accessing to positioning means through automatization of the shipping business.

Background

In order to prevent and reduce ship accidents, IMO (International Maritime Organization), a United Nations specialized agency with responsibility for the safety and security of shipping and the prevention of marine pollution by ships, has enacted an ISM (International Safety Management) Code, a safety and management system, to enforce all maritime companies to observe the Code. The ISM Code cover all aspects of international shipping including ship structure itself for maritime safety and maritime environmental preservation and physical stability of facilities, qualification certification and capability. To this end, a ship must collect, record, keep and maintain the safety management status of a ship according to the safety management system regulation.

However, accessibility and utilization deteriorate due to businesses being realized by paper documents during the conventional ISM operation, and the conventional ISM operation is relatively inefficient over a method utilizing a smart device. Thus, the conventional ISM operation could not be concentrated to a safety operation business which is a fundamental object of ISM enactment, many operation times were allocated to document operations, and inefficient dual operations were implemented such as re-inputting documents manually recorded at the operation sites into a document file report in a personal computer, whereby problems including omission and erroneous input of data were inevitably generated.

Thus, it is essential to build up an e-ISM system (a position-based automatic operation system for ships) grafted with ICT (Information Communication Technology) during ISM operation in order to prevent accidents and cost reduction through systematic management of ships.

The Korea laid-open patent No. 10-2002-0030482 discloses a teaching in which ship/cargo information is provided according to request by a ship owner or a shipper by establishing ship information and cargo information in a database by being provided in real time with the ship information and cargo information from the ship owner or the shipper using a communication network. In addition, the Korea laid-open patent No. 10-2003-0096188 teaches a system interworking electronic mail transmitted from a ship with a land computer system.

However, these prior arts suffer from the disadvantages of not being related to or being remote from ISM activities inside ships because of being simply limited to information provided between ships and land, and to information sharing technology.

### CITED REFERENCE DOCUMENT

[Korea laid-open Patent] 10-2002-0030482

[Korea laid-open Patent] 10-2003-0096188

### SUMMARY OF THE DISCLOSURE

The present disclosure provides a smart ship business device configured to automatize a system inspection and a business handling by being automatically provided with relevant business documents or check lists depending on an operator position inside a ship.

Technical subjects to be solved by the present disclosure are not restricted to the above-mentioned description, and any other technical problems not mentioned so far will be clearly appreciated from the following description by the skilled in the art.

In one general aspect of the present disclosure, there is provided a smart ship business device, the device comprising:

positioning means installed at an operation area of a ship;

a positioning communication unit communicating with the positioning means;

a second data extraction unit configured to extract a second data from a first data matching to the positioning means;

an input unit configured to receive business information on the second data; and

a portable terminal mounted with a transmitter configured to transmit to outside a third data inputted with the business information on the second data.

### Advantageous Effects

A smart ship business device according to the present disclosure is such that when a staff or a crew is moved to a particular place, a business contents or check list to be handled at the moved place is automatically displayed on a portable terminal. When the staff inputs a check point and transmits the check point wiredly or wirelessly to a business main server, the smart ship business device according to the present disclosure can clearly grasp when and who a relevant matter has been performed or inspected.

Furthermore, the smart ship business device according to the present disclosure can eliminate the cumbersomeness of re-inputting documents using a personal computer because the documents can be handled automatically instead of the existing manual work, can shorten a processing time and can reduce an erroneous input and an omission generation.

Still furthermore, the smart ship business device according to the present disclosure can reduce accidents caused by human errors of crews. The possibility of missed business can be greatly reduced, because necessary check points on matters not ascertained in advance by crews can be automatically displayed on a portable terminal when the crews pass by a predetermined area in a ship while carrying the portable terminal.

The ship position-based automatic business system according to the present disclosure can greatly reduce the work load over the existing manual work, whereby an efficient ship management can be made possible.

### BRIEF DESCRIPTION OF DRAWINGS

FIG. 1 is a schematic block diagram illustrating a smart ship business device according to the present disclosure.

FIG. 2 is a schematic block diagram illustrating a portable terminal according to the present disclosure.

FIG. 3 is a schematic view exemplifying an activated position designation table inside a second data extraction unit according to the present disclosure.

FIG. 4 is a schematic block diagram illustrating a flow in which data is transmitted according to the present disclosure.

FIGS. 5 to 8 are schematic views illustrating an interface of a portable terminal according to the present disclosure.

FIG. 9 is a schematic view exemplifying a format of a report document according to the present disclosure.

### DETAILED DESCRIPTION OF THE DISCLOSURE

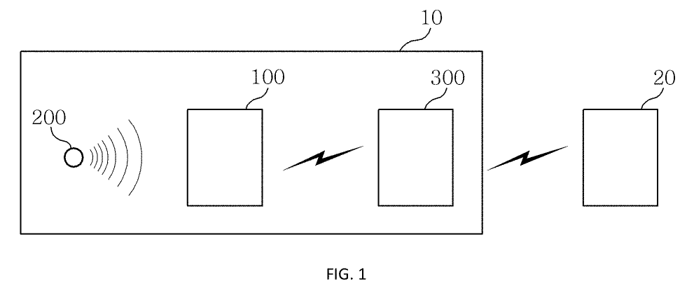

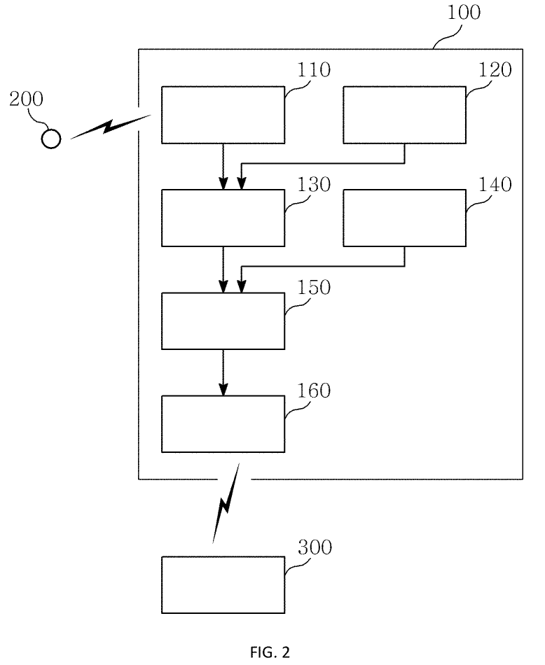

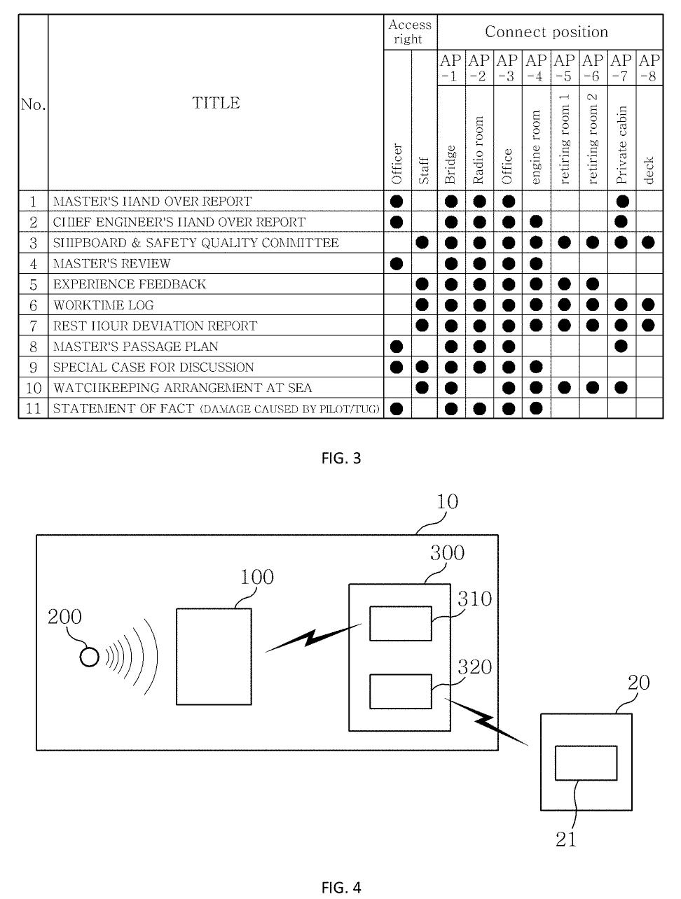

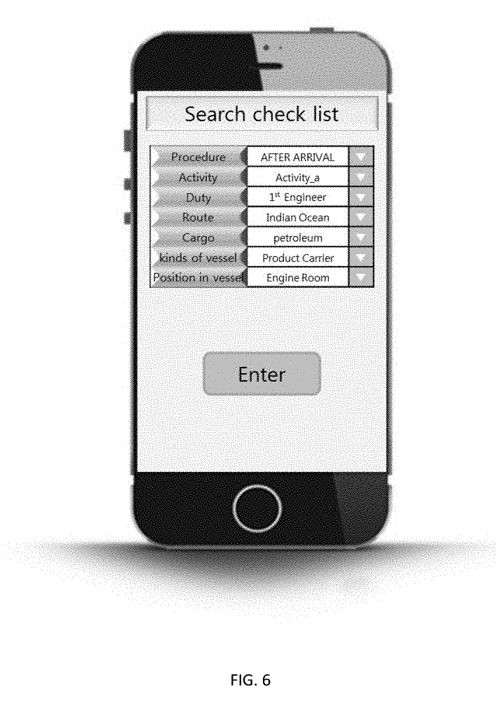

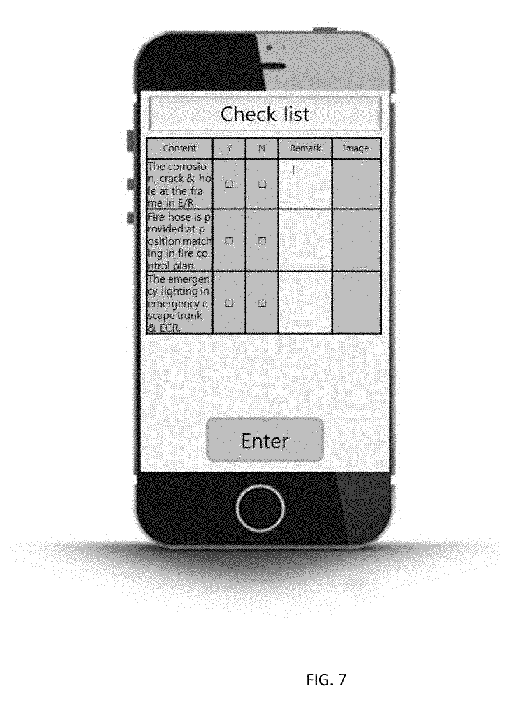

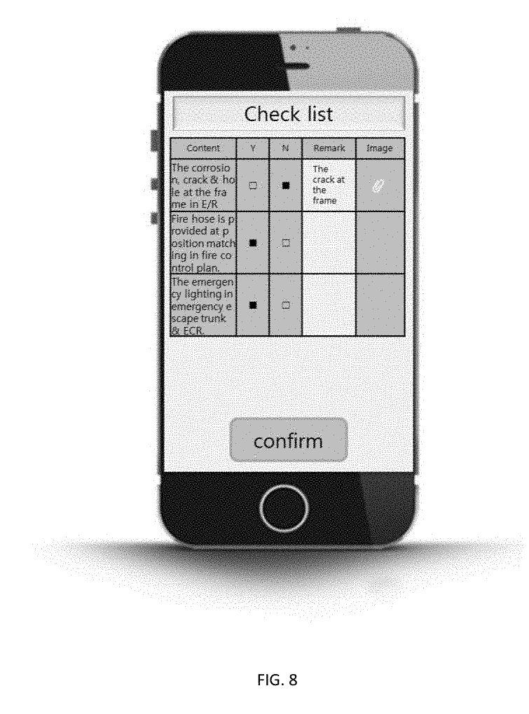

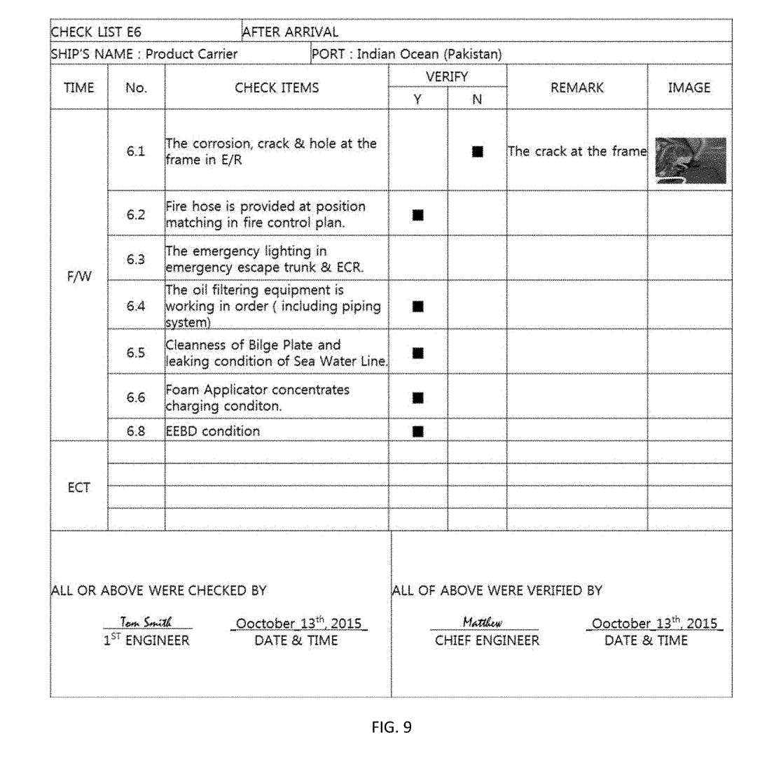

The configuration and function of the smart ship (or shipping) business device according to the present disclosure will be described in detail with reference to the accompanying drawings of FIGS. 1-9.

The smart ship business device according to the present disclosure can automatically provide a business data in real time according to business (operation) area through a portable terminal (100), and provide a completed report by automatically collecting and organizing business (operation) information inputted by a staff (crew, crewman).

The smart ship business device according to the present disclosure can handle (process) business according to ISM Code, can process information necessary for safe navigation of a ship (10) through a smart device, and can input the data to a server (300) of the ship (10) wiredly or wirelessly using the smart device.

The smart ship business device according to the present disclosure may include positioning means installed at a business area of the ship (10), and a portable terminal (100) inputted and outputted with business data related to a relevant business area. The business data of the portable terminal (100) is finally collected by being transmitted to the server (300) of the ship (10) and business contents may be reported to a shipping company in land (20).

The business data may be defined as a first data, a second data and a third data, the details of which will be described later in detail.

The first data may be one of navigation (voyage) information, engine information, E-ISM documents, check lists, ship equipment manuals and ship business education data. Furthermore, the first data may be information necessary for being readable in a ship business area such as cabin including bridge, office room and pump room. The navigation information may be information necessary for navigation such as latitude, longitude, radar information, and seaway information. The engine information may be information on each engine of the ship (10). E-ISM documents may be information electronically documented for business processing in response to the ISM Code and safe navigation of the ship (10). The check list may be a list on items necessary for recordation of business (operation) when a user performs the business in the ship (10). The ship equipment manual may be a manual on various types of equipment installed inside the ship (10). The ship business education data may be educational data for educating crews with information basically well-informed with by the crews.

The first data may be stored en bloc in the portable terminal (100) from outside regardless of communicating or not communicating with positioning means. The first data may be stored in the portable terminal (100) by being inputted wiredly or wirelessly from an outside device.

Meantime, the second data may be defined by a data so selected as to cater to a particular position in the first data. The second data means information matching to position related information of positioning means in the first data. For example, the second data may be a business document or a check list of items to be handled in a relevant cabin when a crew or a staff at work enters the cabin including a bridge, an office or a pump room. The portable terminal (100) may receive an intrinsic communication signal transmitted from the positioning means. The portable terminal (100) may extract a part of data relevant to the first data in response to the received communication signal, and the extracted data may be the second data. That is, the second data may be a business (task) list related to a ship business (operation) area currently positioned by the portable terminal (100). Thus, the crew may recognize the second data and perform the business through the portable terminal (100).

The present disclosure can automatically extract, from the first data, the second data which is a business list required to be performed at a current position, whereby all the businesses of the crew can be automatized by automatically providing the extracted second data to the crew.

Meantime, the third data may be defined by a data completed of input of necessary business contents. For example, the third data may be a data where business information inputted into the portable terminal (100) is mixed for each input field of the second data by performing, by a crew, a business necessary for the second data. The third data may be transmitted to the server (300) of the ship (10) through a transmitter (160) of the portable terminal (100). The first data may be defined by a data initially inputted to the portable terminal (100), the second data may be defined by a data selected to be matched the positioning means in the first data, and the third data may be defined by a data in which the business information performed by the user is inputted or the business information is combined.

The positioning means may be at least one of a beacon, an NFC and a radio communication module adopting an RFID method. The positioning means may be installed at a cabin including various bridges, offices, pump rooms, engine rooms and operation rooms inside the ship (10), where the cabin may mean a ship operation area. The positioning means may transmit mutually different communication signals in response to installation positions. The communication signal of each positioning means may be distinguished by an intrinsic IP. The positioning means may assist a crew in recognizing positions by automatically or transmitting at all times a predetermined communication signal from a cabin of the ship (10). The positioning means may be used in recognizing positions by reacting with the portable terminal (10) of the crew who has entered a relevant cabin.

The portable terminal (10) may detect an intrinsic communication signal of the positioning means paired with the portable terminal (10) when a crew arrives at an arbitrary cabin while carrying a portable terminal (10), where the portable terminal (100) may ascertain which cabin the crew has entered by interpreting the intrinsic communication signal of the positioning means.

For example, when a crew enters a bridge, a positioning communication unit (110) of the portable terminal (100) may automatically recognize the IP of the positioning means inside the cabin which is a particular position, and may activate position related information called a cabin by converting the IP, and may enable a relevant crew to recognize that the portable terminal (100) possessed by the relevant crew is positioned at the bridge.

The positioning means may transmit position related information corresponding to a business area of the ship (10) or may transmit an intrinsic communication signal. When the portable terminal (100) comes in a communication scope of the positioning means, the portable terminal (100) and the positioning means are paired, the positioning communication unit (110) installed at the portable terminal (100) can receive the position related information from the positioning means.

The positioning means may transmit its own intrinsic IP, and the portable terminal paired with the positioning means may receive the intrinsic IP from the positioning means, and extract a position value corresponding to the intrinsic IP from a memory or a look-up table. In addition, the positioning means may directly transmit position related information corresponding to its intrinsic IP to the portable terminal.

Thus, the “position related information” may include an intrinsic IP of the positioning means convertible to a position value, a position value directly transmitted by the positioning means paired with the portable terminal, a current position value of the portable terminal, a current position value of the positioning means and all types of information capable of obtaining those mentioned above.

The portable terminal may ascertain position related information including which cabin a crew or the portable terminal has arrived at by interpreting the communication signal of the positioning means or by interpreting the IP. A server of the ship or a server on the land may be prepared with a ship business report corresponding to the position related information.

The positioning means may transmit the position related information capable of obtaining a position value of a business area in the ship. For example, the positioning means may be an active communication means capable of forming an LAN (Local Area Network) by directly generating a communication signal, and may be one of an active beacon, an active NFC and an active RFID. When the positioning means directly form an LAN, the positioning means may not be connected to the server of the ship.

The active beacon can broadcast at all times its own intrinsic IP or position related information corresponding to the intrinsic IP. When the beacon transmits its own intrinsic IP, the intrinsic IP may be converted to position related information of the beacon by the portable terminal. Meantime, when the beacon transmits the position related information by converting its own intrinsic IP, the portable terminal can directly obtain the position related information.

For example, the positioning means may be inactive communication means incapable of directly generating a communication signal, and may be one of an inactive beacon, an inactive NFC and an inactive RFID. At this time, when the portable terminal transmits a communication signal at all times, and when the communication signal of the portable terminal recognizes an active positioning means, the position related information of a relevant positioning means can be read, and the position related information can be utilized based on a selection standard of the second data. The inactive positioning means suffice to satisfy an environment reactable to the communication signal of the portable terminal without the need of connecting its own communication network.

This exemplary embodiment may have an advantage of obtaining position related information as long as the portable terminal accesses to the positioning means such as inactive beacon even without a communication infrastructure being built up inside the ship. A communication device forming its own communication network may be utilized as the positioning means by further expanding this exemplary embodiment. That is, the positioning means may be a radio repeater capable of forming its own communication network. When an IP address of a radio repeater is learned by information on which radio repeater out of several radio repeaters the portable terminal is connected to, current position related information of the portable terminal can be recognized. This exemplary embodiment has an advantage of utilizing an AP (Access Point) for building up a radio communication network installed inside a ship as the positioning means.

For example, the positioning means may be a plurality of radio repeaters (AP: Access Point) connecting a radio communication between the portable terminal (100) and the server (300). The server (300) or the portable terminal (100) can access to a look-up table corresponded to an intrinsic installation position at each radio repeater.

A second data extraction unit (130) may extract from the first data the second data corresponding to the installation position of the positioning means by searching an installation position of a particular radio repeater connected by the portable terminal (100). The look-up table is stored in the portable terminal (100) or the server (300), and is preferable to be disposed at the portable terminal (100). This is because there generally exists an area inside a ship (10) where communication is not smooth, and therefore, the communication between the portable terminal (100) and the server (300) is not smooth at a place where the crew is positioned. Thus, it is preferable that the look-up table be stored in the portable terminal (100) in order to recognize a position at all times even at a place where communication is impossible.

If the exemplary embodiment is further expanded, the positioning means may be a radio repeater connecting a radio communication such as LAN or Wi-Fi between the portable terminal (100) and the server (300) at a business area of the ship (100) well equipped with communication infrastructure. When the positioning means is a radio repeater, a crew can not only recognize a position through the positioning means, but also immediately transmit the prepared third data to the server (300) through the positioning means.

Meantime, there may be a problem of which positioning means will obtain its own position related information by being connected to which positioning means when several positioning means are installed. A communication signal of a particular positioning means may be overlapped with a communication signal of business area in other ships by being transmitted to outside of a business area of the ship installed with the positioning means to thereby cause confusions in recognizing a position.

In order to recognize an accurate position, the positioning means may be a communication module configured to limit a scope of transmitting a communication signal to a predetermined area. The positioning means may be a communication module transmitting a communication signal in an anisotropic manner. For example, in case of beacon, when a transmission direction of a communication signal is controlled to a particular direction, the positioning means may be adequately a positioning means that is limited to a predetermined section in the transmission scope.

The ship (10) is made of steel structure, and a communication signal generated from inside a particular cabin of the ship may be difficult to be emitted outside of the cabin due to being blocked by a steel wall except for a cabin door. Thus, a communication signal can be limited to be restricted to within a particular cabin when a direction of the communication signal of the communication module is a direction opposite to that of the cabin door, or a direction facing the cabin door.

Meantime, the positioning means may be a communication module of various methods in accordance with a working environment or a working situation. For example, when a crew arrives at a business area of a ship, a business document or a check list corresponding to a particular business area may be activated through the portable terminal (100). At this time, when the business area of the ship is a common cabin of no risk element, a communication module of beacon type or Wi-Fi method will preferably suffice. However, when a business area of the ship is a cabin handling a dangerous article, or an area difficult to be accessed by a crew, a communication module of NFC or RFID (Radio Frequency Identification) method will be preferable to enable position recognition without access by the crew.

In consideration of the above mentioned discussions, it should be apparent that a crew can obtain position related information from a beacon by possessing a portable terminal (100) that directly communicates with the beacon. Meantime, when the business area of the ship is a dangerous area, the beacon may be installed at the dangerous area, and an additional communication device capable of relaying a beacon signal to a safe area must be installed, where the crew can obtain position related information of a beacon by indirectly communicating with a beacon of the dangerous area by connecting the portable terminal (100) to the additional communication device at the safe area.

The portable terminal (100) may include a positioning communication unit (110) communicating with the positioning means, a second data extraction unit (130) extracting from a first data a second data matching to the positioning means, an input unit (140) receiving business information on the second data and a transmitter (160) transmitting to outside a third data inputted with the business information of the second data. Meantime, the portable terminal (100) may further include a storage unit to store the first, second and third data.

The storage unit may include a first data storage unit (120) to store the first data, a second data storage unit to store the second data, and a third data storage unit to store the third data. The positioning communication unit (110) may receive position related information allocated to the positioning means through radio communication with the positioning means. The positioning communication unit (110) may obtain a current position value of the portable terminal (100) by receiving a communication signal transmitted by the positioning means and recognizing the received communication signal. The positioning communication unit (110) may be disposed with a look-up table in which a communication signal of positioning means of each area or an IP address is corresponded to an installation position of the positioning means of each area.

The positioning communication unit (110) can recognize an installation position of the positioning means by receiving a communication signal transmitted by the positioning means and by analyzing an address (IP address) of the received communication signal. Thus, the position related information including a current position value positioned by the portable terminal (100) connected to the positioning means can be calculated. The calculated position related information may be transmitted to the second data extraction unit (130).

The second data extraction unit (130) may extract a second data matching to the positioning means by being received with the position related information recognized by the positioning communication unit (110) and searching from the first data a data corresponding to the position related information. The second data extraction unit (130) may prepare a second data by extracting a data corresponding to a business area of a ship (10) extracted from the communication signal of the positioning means in the first data.

Meantime, the second data extraction unit (130) may extract a second data by applying additional information besides the position related information provided by the positioning means. For example, the second data extraction unit (130) may extract from the first data storage unit (120) a particular first data corresponding to at least one of user personal information, a current time and position related information of the portable terminal (100) and provide as a second data. For example, even in the same business area of a ship, business items may be different to be checked and recorded depending on position (captain, chief officer, second officer, third mate, boatswain, chief wireless operator, first cook, chief engineer, first engineer and second engineer) of crew. As a result, there is a need of extracting a second data matching to the position of the crew from the first data. Thus, parameter of personal information of crew, a current time and position related information may be applied as a second data extraction standard.

The crew may input a business performance result (e.g., collection, record, maintenance and checked result) on the second data to the portable terminal (100) through the input unit (140). The input unit (140) may be a touch screen of a smart device.

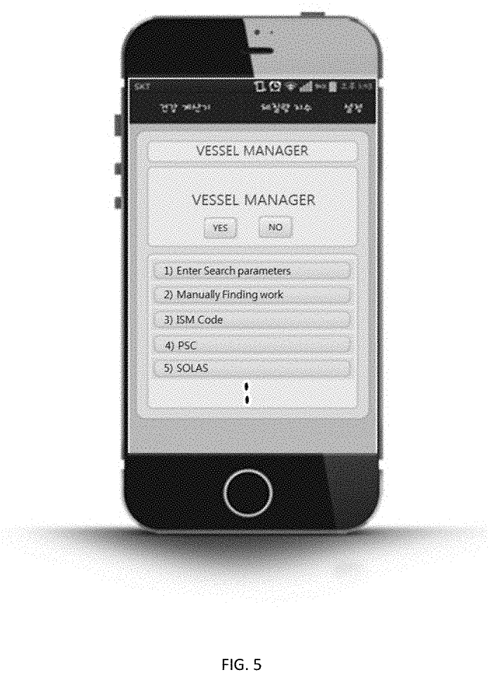

The input unit (140), depending on the types of second data, may vary UI (User Interface) of screen in order to receive a business result. Referring to FIGS. 5 to 8, various interfaces may be provided that can be inputted by a user for the extracted data. The crew can input business performance contents related to the second data through the input unit (140). A third data generation unit (150) may generate a third data by combining and re-organizing the second data received from the second data extraction unit (130) and the business information transmitted from the input unit (140) to cater to each field.

The transmitter (160) may transmit the third data to the server (300) of the ship (10). The third data may be transmitted to the server (300) through the transmitter (160). The server (300) can prepare a complete document by collecting and organizing each third data inputted by a plurality of crews to the server (300) through the transmitter (160). The completed document may be reported to the land through the server (300) of the ship (10). Objects receiving the document at the land (20) may be a shipping company, a shipper and a port.

The transmitter (160) may transmit the third data to the server (300) of the ship (10) wiredly or wirelessly. In case of wired connection, the third data may be inputted to the server (300) by being directly connected to a PC which is the server (300) through the wired cable. In case of wireless connection, the transmitter (160) can transmit the third data to the server (300) of the ship (10) through a communication network of radio repeater, when the portable terminal (100) is connected within a communication accessible scope of radio repeater communicable with the server (300) of the ship (10). The radio repeater may be a communication module disposed separately from the positioning means, and the positioning means may co-function as a radio repeater. The positioning means may not be limited to the radio repeater, and may be an independent communication module continuously emitting an intrinsic particular communication signal without communication connection with other communication devices.

The transmitter (160) may transmit to the server (300) of the ship (10) an entire third data most recently stored from the third storage unit. Meantime, the transmitter (160) may transmit only the newly updated third data to the server (300) of the ship (10) by choosing only the newly updated third data by determining whether the third data has been newly updated subsequent to the existing transmission time.

The server (300) of the ship (10) may transmit the third data or a business report document prepared based on the third data to the land (20). When the server (300) of the ship (10) transmits the third data or the business report document to the land, only the newly updated third data or business report document subsequent to recently transmitted time may be selected and transmitted to the land, or the third data or business report document regardless of update may be transmitted to the land.

Meantime, the transmitter (160) may push or alarm whether connected to the server (100) to the portable terminal (100) when the portable terminal (100) approaches an area installed with radio repeater communicably connected to the server (100) of the ship (10). Thus, the crew can determine updatability whether to immediately upload a currently performed business to the server (100) of the ship (10) by seeing the push or alarm of the transmitter (160).

The storage unit may be a memory device storing a first data, a second data and a third data. The storage unit may be stored with a log to data change such as read or write of data. The storage unit may include a first data storage unit (120), a second data storage unit and a third data storage unit. The first data storage unit (120) may be stored with a first data. The first data storage unit (120) may obtain the first data by being communicably connected to an outside wiredly or wirelessly.

The second data storage unit may store a second data calculated from the second data extraction unit (130). The second data may be extracted according to selection standard of position related information recognized by the positioning means, user personal information, and current time. The second data storage unit may store the position related information of portable terminal, user personal information, and current time by dividing the position related information of portable terminal, user personal information, and current time.

The third data storage unit may store a third data in which the business information performed by the crew is combined or mixed for each input field of the second data. The third data may store the position related information of portable terminal, user personal information, and current time by dividing the position related information of portable terminal, user personal information, and current time.

When the size of the data is large, it may be ineffective to store all the data in the portable terminal, and to extract particular information by searching from the portable terminal. In order to improve the ineffectiveness, a method of attaching and detaching the portable terminal may be used in which elements capable of performing calculation function is installed in the portable terminal and simple data is stored in OTG (On-The-Go) or a USB memory.

In one exemplary embodiment, the portable terminal (100) may include at least one of a first terminal disposed with a radio communication means wirelessly communicating with outside, and a second terminal including a memory storing a data. For example, the first terminal may be a smart device equipped with all types of radio communication means communicating with outside wiredly and wirelessly. The first terminal may be a portable smart device such as a smart phone, a smart pad and a tablet PC of communicable Bluetooth and capable of Wi-Fi communication. When the first terminal and the second terminal are integrated, the second terminal may be a memory chip embedded in the smart device.

Meantime, the first terminal and the second terminal may be respectively a separate device connected to each other via wired and wireless manner. At this time, the second terminal may be a memory device such as OTG USB (Universal Serial Bus On-The-Go) and external hardware attachably and detachably connected to the smart device, whereby restriction in memory limit of smart device can be overcome, and a new system can be installed on a first terminal by simply attaching and detaching a second smart terminal.

For example, when a large quantity of ship equipment manuals is to be inputted to a first data, or when a first data is to be frequently replaced due to types of ships, or when a first data is to be frequently revised, or when an entire system is to be frequently upgraded, and when all modules and data are stored in the portable terminal, it would be very cumbersome to remove and install programs. Thus, the frequently revised items are prepared in a second terminal type storing the frequently revised items, and when various types of second terminals are attached to and detached from the portable terminal, the first data or system programs can be easily replaced and updated to advantageously shorten the searching and extracting times.

Meantime, the third data completed as a business result of the crew through the portable terminal (100) may be transmitted to the server (300) of the ship (10). The server (300) of the ship (10) may be singularized or dualized. The server (300) of the ship (10) may include a business server (310) collecting and managing the business data, and a communication server (320) taking charge of communicating with the land. The business server (310) may be inputted with a third data inputted into the portable terminal (100), and information of various sensors and equipment through wired communication sections.

The information of ship (10) may be information from AIS, RADAR, ECDIS, GYRO, INDICATOR, M/ENG and VTS.

The AIS (Auto Identification System) is a system capable of transmission/reception of automatic remote recognition signal on position of a ship (10).

The RADAR is equipment capable of identifying position of a target by receiving a reflective wave of the target by emitting an electromagnetic wave.

The ECDIS (Electronic Chart Display and Information System) is an electronic navigational chart system of ship (10) displaying navigational information by a computer instead of displaying the navigational information using paper.

The ECDIS is a navigational system allowing an ENC (Electronic Navigational Chart) to be actually used in navigation. The ECDIS may be connected to navigational sensors to help a navigator to plan navigation and to monitor sea route in addition to electronic navigational chart, and may selectively display navigational information along with positions of ship (10) at every moment.

The GYRO is equipment used in measuring directions or rotational angular velocity using rotational inertia of a high speed revolver. The GYRO may constantly maintain the directions and balance of a ship (10).

The INDICATOR is a measuring instrument measuring a relation between cylinder pressure change of an internal engine and movement of piston of a ship (10).

The M/ENG means a main engine.

The VTS (Vessel Traffic Service) is a passage service business to enhance safety in passages caused by explosive increase in maritime traffic, increase in dangerous cargo and potential environmental pollution, or to enhance efficiency of operation. The surrounding circumstances and maritime traffic situations can be provided in good time within the VTS area by the VTS. The VTS can provide information to allow the ship (10) to help decide navigational decision making.

A business server (310) can prepare a one report document by collecting a plurality of third data prepared through the portable terminal (100) by each crew (a plurality of individual crews each different in grade) and equipment information of the ship (10) automatically inputted wiredly and wirelessly. The report document at this time may be a document (document of PDF, hangul or word) immediately viewable in paper format, or a document of symbolized coded format.

The communication cost is high because communication is connected between a ship (10) and the land (20) through satellites. Thus, a document is converted in symbolized codes to minimize the data capacity of document, whereby the satellite communication cost can be reduced. There may be required a data conversion code on codes when the symbolized codes are used by a land server (21).

A communication server (320) may transmit mails to be transmitted to the land (20). The report documents prepared in ship smart business device according to the present disclosure may be finally reported through the communication server (320). Now, operation and function of the present disclosure will be described in detail.

The portable terminal (100) may be stored with a first data at an initial setting. The first data may include navigational information related to a ship (10) business, engine information, an E-ISM document, a check list, a ship equipment manual, a ship business educational data and the like. At this time, the first data may store only a part of relevant data depending on types of ships, navigational routes and cargoes in consideration of storage capacity of the portable terminal (100).

The crew may input own personal information in the portable terminal (100) when starting his or her duty. The business of the ship (10) may be changed depending on duty responsibility of a crew, such that the personal information may be used only at least partially among variables for extracting optimized second data. The personal information input method may be a format in which detailed personal information (duty of responsibility, name, age, etc.) is inputted in the system in advance, a recognition code and a password corresponding thereto are provided and log-in/log-out is made by the provided recognition code.

When the crew approaches a ship business area while possessing the portable terminal (100), the portable terminal (100) may receive a communication signal of the positioning means of relevant ship business area. The portable terminal (100) may recognize its own position by interpreting the communication signal from the positioning communication unit, and display a data related to the relevant ship business area among the first data by extracting the data from the second data.

The crew may perform an input-necessary business on the second data displayed on the portable terminal (100) and may input a business performance result through the input unit (140). The portable terminal (100) may prepare a third data by combining or mixing the business information inputted to the input unit (140) and the second data for each field.

The portable terminal (100) may transmit the third data to the server (300) of a ship (10) under an environment communicable wiredly and wirelessly with the server (300) of the ship (10). The server (300) of the ship (10) may prepare a report document by collecting a plurality of third data transmitted by each crew. The report document may be reported to the ship company, ship owner and ship port through the communication server (320).

Although the smart ship business device has been described and explained according to exemplary embodiments, the present disclosure is not limited to a particular exemplary embodiment but many alternatives, modifications, and variations will be apparent to those skilled in the art within the metes and bounds of the claims.

Therefore, it should be understood that the above-described embodiments are not limited by any of the details of the foregoing description, unless otherwise specified, but rather should be construed broadly within the scope as defined in the appended claims.

What is claimed is:

1. A smart ship business device, the device comprising:
positioning means installed at an operation area of a ship;
a positioning communication unit communicating with the positioning means;
a second data extraction unit configured to extract a second data from a first data matching to the positioning means;
an input unit configured to receive business information on the second data; and
a portable terminal mounted with a transmitter configured to transmit to outside a third data inputted with the business information on the second data.

2. The smart ship business device of claim 1, wherein the portable terminal includes at least one of a first terminal mounted with wireless communication means wirelessly communicating with an outside, and a second including a memory to store data.

3. The smart ship business device of claim 1, wherein the portable terminal includes at least one of a first terminal and a second terminal, wherein the first terminal and the second terminal are an integral device, and the second terminal is a memory chip embedded in the first terminal, and wherein
when each of the first terminal and the second terminal is a wirelessly or wiredly connected separate device, the second terminal is a memory device including at least one of an OTG (On-The-Go) attachably and detachably connected to the first terminal, a USB (Universal Serial Bus) and hard disc, and
a new system is installed on the first terminal or a new data is inputted to the first terminal by simply attaching the second terminal to or detaching the second terminal from the first terminal.

4. The smart ship business device of claim 1, wherein the portable terminal includes a first data storage stored with the first data, wherein the first data is stored en bloc in the first data storage from outside regardless of whether to communicate with the positioning means.

5. The smart ship business device of claim 1, wherein the second data extraction unit receives position related information from the positioning communication unit, and extracts the second data matching to the positioning means by searching a data corresponding to the position related information from the first data.

6. The smart ship business device of claim 1, wherein the portable terminal includes a third data generating unit configured to generate a third data by mixing business information inputted from the input unit for each input field of the second data.

7. The smart ship business device of claim 1, wherein the portable terminal includes a third data storage configured to store the third data, wherein the transmitter detects whether a wireless communication is connected to a server installed on a ship, and transmits the third data stored in the third data storage to the server installed on the ship when it is detected that the wireless communication is connected to the server.

8. The smart ship business device of claim 1, wherein the first data includes at least one of sailing information, engine information, E-ISM documents, check lists, ship equipment manual, ship business educational data, and information necessary for reading at the cabin,
the second data is a first particular data extracted by the second data extraction unit from the first data storage corresponding to at least one of user personal information of the portable terminal, a current time and the position related information, and
the third data is the business information inputted from the input unit mixed by the third data generating unit for each input field of the second data.

9. The smart ship business device of claim 1, wherein the positioning means transmits mutually different communication signals depending on an installation position, and each of the communication signals of the positioning means is distinguishable by an intrinsic IP (Internet Protocol),
the positioning means transmits the communication signals from a cabin of a ship, reacts with the portable terminal of staff entering the cabin, and is used for recognizing a position of the staff or a position of the portable terminal,
the portable terminal detects the communication signal of the positioning means installed at the cabin when the staff arrives at the cabin with the portable terminal, the portable terminal ascertains a position related information including at which cabin the staff or the portable terminal has arrived by analyzing the communication signal or the IP of the positioning means, and
the positioning means prepares a shipping business report including business processing information in response to an ISM code inputted through the portable terminal and business processing information necessary for safe navigation of a ship, and transmits the shipping business report and the business processing information to a land.

10. The smart ship business device of claim 1, wherein the positioning means includes at least one of a beacon, an NFC (Near Field Communication) and an RFID (Radio Frequency Identification) employed by a wireless communication module,
the positioning means transmits position related information corresponding to a position value of a business area of a ship,
the positioning communication unit receives the position related information from the positioning means when the portable terminal comes within a communication scope of the positioning means.

11. The smart ship business device of claim 1, wherein the positioning means is a communication module configured to limit a scope of transmitting the communication signal to a predetermined area, or a communication module transmitting the communication signal in anisotropic manner, or the positioning means limits the transmission scope of the communication signal to a predetermined section by controlling a transmission direction of the communication signal to a particular direction.

12. The smart ship business device of claim 1, wherein the positioning means includes a plurality of radio repeaters, wherein the plurality of radio repeaters is installed inside the ship to connect a radio communication between the portable terminal and the a server installed on the ship,
the server or the portable terminal is accessed to a look-up table corresponding to an intrinsic installation position for each radio repeater, and
the second data extraction unit searches from the look-up table an installation position of a particular radio repeater connected by the portable terminal among the plurality of radio repeaters, and extracts the second data corresponding to the installation position of the particular radio repeater connected by the portable terminal.

13. The smart ship business device of claim 1, wherein the positioning means is passive communication means incapable of directly generating a communication signal by itself, includes any one of a passive beacon, a passive NFC and a passive RFID,
the portable terminal reads out position related information of a relevant positioning means when a communication signal of the portable terminal recognizes a particular positioning means among the positioning means, and
the position related information becomes a selection standard of the second data in the portable terminal.

14. The smart ship business device of claim 1, wherein the second data extraction unit extracts the second data by applying additional information, in addition to the position related information provided by the positioning means,
the second data extraction unit extracts, from the first data storage, the additional information including at least one of user personal information of the portable terminal and a current time, and a particular first data corresponding to the position related information to generate the second data.

15. The smart ship business device of claim 1, wherein the transmitter transmits, to the server of the ship, an entire third data most recently stored in the third data storage, or sorts out only a newly updated third data by determining whether the third data has been updated subsequent to the existing transmission point and transmits the newly updated third data to the server of the ship.

16. The smart ship business device of claim 1, wherein the transmitter pushes or alarms to the portable terminal whether communication is connected to the server of the ship, and
an uploadable time of business performed by the staff of the ship is determined by the push or alarm of the transmitter.

17. The smart ship business device of claim 1, wherein a server connected by the portable terminal is provided on a ship,
the server includes at least one of a business server configured to collect or manage business information of the ship and a communication server configured to take charge of communication with the land,
the business server is inputted with at least one of the third data, ship sensor information and ship equipment information,
the business server prepares a ship business report to be transmitted to the land by collecting a plurality of third data prepared by each staff through the portable terminal, or prepares a ship business report to be transmitted to the land by collecting the ship sensor information automatically inputted wirelessly or wiredly or the ship equipment information, and
the communication server transmits the ship business report to the land.

18. A smart ship business device, the smart ship business device: automatically providing a business data changed according to a relevant business area of a ship or a business data related to the business area in real time through a portable terminal; and completing a ship business report by automatically collecting business information inputted by a staff of the ship, wherein the ship business report includes business processing information based on ISM code and business processing information necessary for safe operation of a ship, and the business data inputted through the portable terminal is transmitted to the land by being re-prepared as the ship business report or the business processing information.
